(19) United States
(12) Patent Application Publication
(10) Pub. No.: US 2009/0322747 A1
(43) Pub. Date: Dec. 31, 2009

(54) Graphics processing with hidden surface removal

(76) Inventor: Robert Farrell, Granite Bay, CA (US)

Correspondence Address: TROP, PRUNER & HU, P.C., 1616 S. VOSS RD., SUITE 750, HOUSTON, TX, 77057-2631, US

(21) Appl. No.: 12/215,920

(22) Filed: Jun. 30, 2008

(51) Int. Cl. G06T 15/40

(52) U.S. Cl. 345/422

(57) ABSTRACT

The rapid depth testing for hidden surface removal in graphics processing may be achieved by depth testing representative pixels of a group of pixels. In one embodiment, the worst case pixels of a group of pixels can be identified. The worst case pixels can then be compared to worst case values stored in a hierarchical Z-buffer. Depending on the results, the entire set of pixels of the group may pass or fail the depth test. As a result, in some cases, it is not necessary to depth test every pixel.

### BACKGROUND

This relates generally to graphics processing for integrated circuit processing devices.

In graphics processing, three dimensional objects can be represented as a series of triangles having three points. The three points can be used to establish the so- called plane equation that represents a plane including the three points. The plane equation indicates the orientation of each triangle point relative to a display screen plane.

Hidden surface removal or Z-buffering tracks the depth of pixels to reduce the processing carried out on polygons that are hidden behind other polygons in a scene.

Identifying and culling occluded pixels of polygons may represent a significant opportunity for performance improvement.

### BRIEF DESCRIPTION OF THE DRAWINGS

FIG. 1 is a schematic depiction of a processor-based device in accordance with one embodiment;

FIG. 2 is a depiction of a block of pixels useful in accordance with one embodiment of the present invention;

FIG. 3 is a depiction of the analysis used for depth testing in accordance with one embodiment of the present invention; and

FIG. 4 is a flow chart for depth testing in accordance with one embodiment.

### DETAILED DESCRIPTION

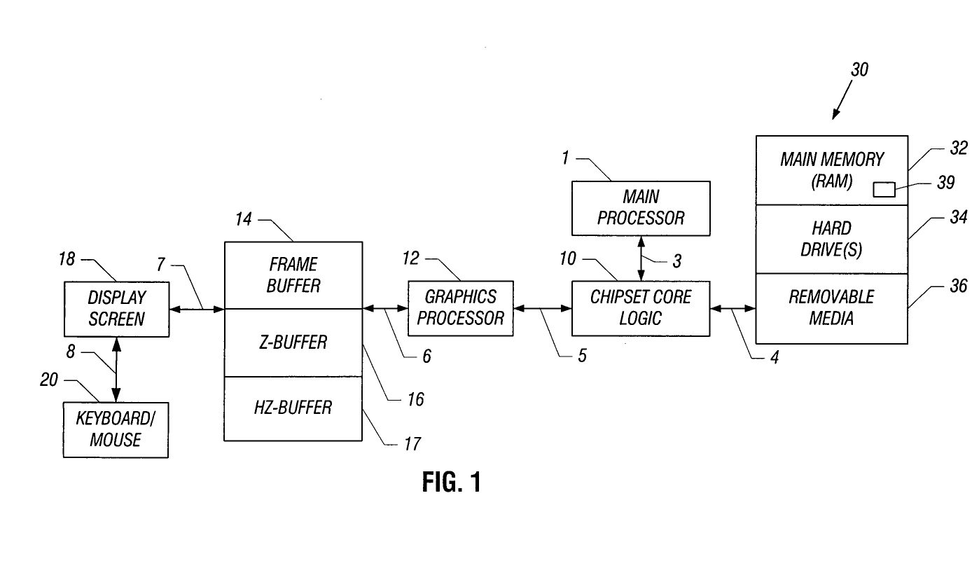

Referring to FIG. 1, a processor-based system, according to one embodiment of the present invention, is capable of high performance three dimensional graphics processing. In one embodiment, the system includes a main processor 1, chipset core logic 10, graphics processor 12, frame buffer 14, Z-buffer 16, HZ or hierarchical Z-buffer 17, display screen 18, keyboard/mouse 20, and memory 30. The memory 30 may comprise any suitable memory storage device and, in one embodiment, includes a main memory 32 implemented with random access memory chips, one or more hard drives 34, and removable media 36, such as magnetic or optical disks.

The processor 1 may be coupled to a chipset core logic via bus 3. The chipset core logic 10, coupled to the graphics processor 12 via a bus 5, may be coupled to the frame buffer, as well as the Z-buffer 16 and hierarchical Z-buffer 17, via bus 6. The frame buffer 14, Z-buffer 16, and hierarchical Z-buffer 17 are coupled to the display screen 18 via bus 7, and display screen 18 is coupled to keyboard/mouse 20 via the bus 8.

Other user interface elements, such as audio speakers, microphones, joy sticks, steering wheels, printers, musical instrument digital interface keyboards, virtual reality hoods, moveable seats, and environments may be part of the processing system, to mention a few examples.

The architecture shown in FIG. 1 is exemplary and is only one of many processing architectures that may be utilized in accordance with some embodiments of the present invention. The memory 30 may constitute a computer readable medium which is any device, whether active or passive, containing computer instructions for instructing a processor or containing computer data, such as a hard disk, a floppy disk, a compact disk, a random access memory, an optical memory, or any semiconductor memory.

In accordance with some embodiments of the present invention, less than all the pixels of a group of pixels may be depth tested instead of testing all the pixels of the group. A depth test is a test of the distance of a particular pixel into the display screen. The depth testing may be used to determine pixels that are occluded. The occluded pixels of a polygon need not be processed. This elimination of occluded pixel processing can improve graphics performance.

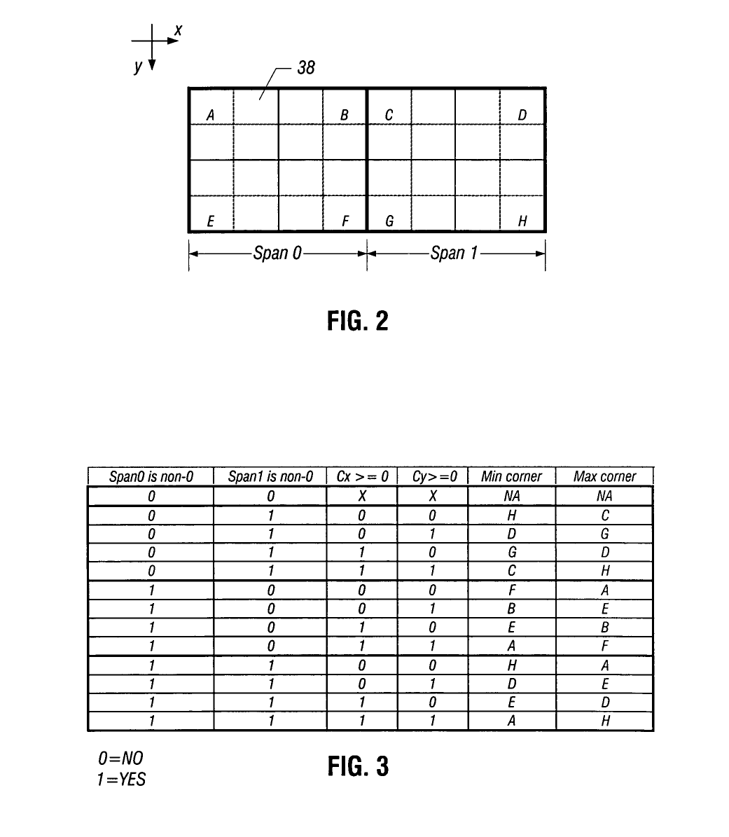

Referring to FIG. 2, a plurality of pixels may be grouped into what may be called a block. The block may include a number of pixels, usually at least four pixels, that are contiguous. The block may be rectangular, but other shapes may also be used. By analyzing the depths of representative pixels of the block, one can determine, in many cases for the block as a whole, whether the block would be occluded. As a result, depth testing may be accelerated since depth testing each and every pixel is not necessary in every case. Likewise, in many cases for the block as a whole, one can determine that the block is not occluded, therefore none of the pixels in the block are occluded and thus testing every pixel is not necessary.

Thus, referring to FIG. 2, in one embodiment, a first rectangularly arranged group of 16 pixels 38 may constitute a span zero and a second group of 16 rectangularly arranged pixels 38 constitute a span one. In this embodiment, the block that is being analyzed constitutes spans zero and one, including 32 pixels which, in some cases, can be analyzed as a group to improve depth testing speed.

The graphics pipeline, including, for example, the flow of data through the graphics processor 12, may provide data that represents triangles, in turn, represented by three points. Each point is associated with a depth or Z value.

A plane equation characterizes the depth of each pixel within the triangle, where Z is the depth:

Z=C₀+Cₓ(x−Xref)+C_{y}(y−Yref).

Thus, the plane equation defines a plane of the pixels forming a triangle and defines a tilt of that plane relative to a display screen. In some embodiments, the coefficients Cₓ and C_{y} and, particularly, their signs are used to determine worst case corners for the entire block, in a block using a rectangular array of pixels. The worst case corners are the corners with the minimum and the maximum depths of any pixels in the block.

As indicated in FIG. 2, the X axis increases from left to right and the Y axis increases from top to bottom in this embodiment. Thus, for example, the pixel D, has a higher X value than the pixels labeled A, B, or C. And the pixel E has a higher Y value than the pixel A. The pixel H has both a higher Y and a higher X value than the pixel A.

The hierarchical Z-buffer or HZ-buffer 17 (FIG. 1) is constructed from the Z-buffer 16 and accumulates the minimum and maximum values for all the previously rendered pixel locations for a block of pixels, being one span in one embodiment. Then, subsequent pixel locations have their polygons tested against the values in the hierarchical Z-buffer 17 to see if those polygons are hidden. If they are hidden, they may be culled, resulting in processing savings.

When testing against the values in the hierarchical Z-buffer, eight different tests are conventionally used in graphics processing. A “less than” test, a “less than or equal to” test, a “greater than” test, a “greater than or equal to” test, an “equal” test, a “not equal” test, an “always pass” test, and a “never pass” test are utilized. Generally, the always pass and the never pass involve no testing whatsoever and are of no interest in the present context.

FIG. 3 illustrates an example of how the depth test is done, in one embodiment, using a rectangular pixel array. The test is based in part on whether or not each span is non-zero. A span is non-zero if at least one pixel in the span is actually “lit” or activated. If no pixel in the span is lit then the span can be ignored during depth testing.

Also, the test determines whether the plane equation coefficients C_{X} is greater than or equal to zero, (i.e. is positive) and whether the plane equation coefficient C_{Y} is greater than or equal to zero (i.e. positive). Then the minimum corner and the maximum corners for the block consisting of the span zero and span one, is identified in the left and right most columns. (Of course, the column or structure defined in FIG. 3 may not actually be utilized in embodiments of the present invention, but is provided primarily for comprehension and illustration of embodiments of the present invention).

Thus, the first horizontal line in FIG. 3 is the situation where no pixel in either span is lit. The first line is, therefore, of no interest in the present context.

The fifth horizontal line is the situation where no pixel in span zero is lit, but at least one pixel in span one is lit. In this case, both coefficients C_{X} and C_{Y} are positive. In such case, given the way that X and Y increase as indicated in FIG. 2, the minimum corner is the pixel C and the maximum corner is clearly the pixel H.

Once the minimum and maximum corners have been determined, the next step, in one embodiment, is to analyze the minimum and maximum corners for a given group of pixels against a value currently stored in the hierarchical Z-buffer 17. For example, if the application for the graphics system uses a “less than” test, then any depth that is lower than the minimum depth value in the hierarchical Z-buffer passes and any depth value larger than the maximum depth fails. In such case, the minimum corner is compared to the maximum value in the hierarchical Z-buffer. If the minimum corner is greater than the hierarchical Z-buffer maximum, then every pixel in the block is greater than the hierarchical Z-buffer maximum value and no pixel in the block passes. Then, the maximum corner in the block at issue is compared to the hierarchical Z-buffer minimum value. If the value of the maximum corner is less than the hierarchical Z-buffer minimum value, then all the pixels in the block are less than the hierarchical Z-buffer minimum value and, in this case, all the pixels of the block pass as a group, without analyzing every pixel.

If neither of these comparisons works, then the savings possible with embodiments of the present invention are not applicable and the values of every pixel may be conventionally compared in the block one-by-one against the values in the hierarchical Z-buffer. In such case, no time savings may be achieved, but, overall, because the tests described herein are often successful, in some embodiments significant time savings may be achieved.

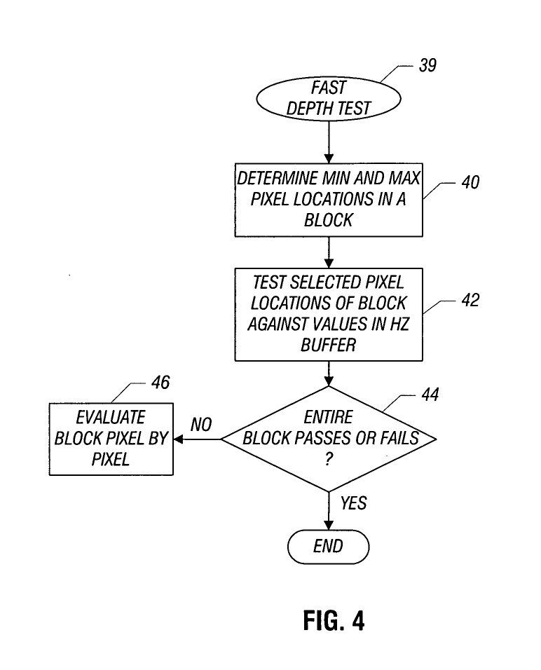

Referring to FIG. 4, in accordance with one embodiment, a sequence for implementing a fast depth test 39 includes a sequence. In one embodiment, the sequence may be implemented in software. In such case, the software representing the sequence 39 may be stored in any suitable storage or memory, including the main memory 32, as depicted in FIG. 1. In such case, the software sequence is stored in a computer readable medium executable by a computer that includes one or more of the processor 1, processor 12, or any other suitable processor of a computer or processor-based system.

As indicated in block 40, the minimum and maximum pixel locations in a block are determined in an embodiment using a rectangular block. In some cases, it may also be determined whether any of the pixels in the block or any of the pixels in any span making up the block are lit. If none of the pixels are lit, the span or block may be ignored.

Then, the selected pixel locations representative of the minimum and maximum values of a block are tested against the minimum and maximum values in the hierarchical Z-buffer 17, as indicated in block 42. The exact test that is done is dependent upon the type of system implemented by the applicable application. In one example, a “less than” test may be utilized, but other tests may also be utilized. In such cases, it is possible to deduce, based on the minimum and maximum values of a group of pixels, whether or not all the pixels would pass or fail the depth test.

As indicated in FIG. 4, in block 44 a check determines whether the block as a whole passes or fails. If so, the processing of the block is done and the next block can be acquired and the processing repeated. If the block neither passes or fails, then a conventional depth test is done (block 46), evaluating each pixel of a block pixel-by-pixel. In this case, the possibility of treating the block as a whole and avoiding the need to test every pixel in the block is not possible.

The size of the block and the constituent span or spans is subject to considerable variation, although in general it would seem to make sense to use at least four pixels in any analysis. In addition, the number of spans may be changed from two and could be any number from one span upwards. It does not matter that some pixels of a span are not lit. In addition, two sets of eight pixels can be analyzed in parallel, in one embodiment.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
using less than all the pixels of a group of pixels to do a depth test for all the pixels of the group.

2. The method of claim 1 including using the coefficients of a plane equation to predict the worst case pixels of the group of pixels.

3. The method of claim 2 including using the coefficients of the plane equation to determine the two worst case pixels of the group of pixels.

4. The method of claim 3 wherein said group of pixels is a rectangular array of pixels, said worst case pixels corresponding to corners of said rectangular array of pixels.

5. The method of claim 4 including using two rectangular spans of pixels to determine the worst cases.

6. The method of claim 2 including determining whether or not at least one pixel of the group is lit.

7. The method of claim 3 including identifying the minimum and maximum depth value pixels of the group as the worst case pixels.

8. The method of claim 7 including comparing the minimum and maximum depth values of the group of pixels to the minimum and maximum values stored in a hierarchical Z-buffer.

9. The method of claim 8 including depth testing at least two blocks of pixels in parallel.

10. An apparatus comprising:
a frame buffer; and
a graphics processor coupled to said frame buffer, said graphics processor to use less than all the pixels of a group of pixels to do depth testing for all the pixels of the group.

11. The apparatus of claim 10, said graphics processor to use the coefficients of a plane equation to predict the worst case pixels of the group of pixels.

12. The apparatus of claim 11, said processor to use the coefficients of the plane equation to determine the two worst case pixels of the group of pixels.

13. The apparatus of claim 12, said processor to use a group of pixels that is in a rectangular array of pixels and said worst case pixels corresponding to corners of said rectangular array of pixels.

14. The apparatus of claim 13, said processor to use two rectangular spans of pixels to determine the worst cases.

15. The apparatus of claim 10, said processor to determine whether or not at least one pixel of the group is lit.

16. The apparatus of claim 12, said processor to identify the minimum and maximum depth value pixels of the group as the worst case pixels.

17. The apparatus of claim 16 including a hierarchical Z-buffer coupled to said processor, said processor to compare the minimum and maximum depth values of a group of pixels to the minimum and maximum values stored in the hierarchical Z-buffer.

18. The apparatus of claim 17, said apparatus to depth test at least two blocks of pixels in parallel.

19. A computer readable medium storing instructions that, if executed, enable a processor to:
use less than all the pixels of a group of pixels to do a depth test for all the pixels of the group.

20. The medium of claim 19 further storing instructions to use the coefficients of a plane equation to predict the worst case pixels of the group of pixels.

21. The medium of claim 20 further storing instructions to use the coefficients of the plane equation to determine the two worst case pixels of the group of pixels.

22. The medium of claim 19 further storing instructions to process a rectangular array of pixels as said group of pixels, said worst case pixels corresponding to corners of said rectangular array of pixels.

23. The medium of claim 22 further storing instructions to use two rectangular spans of pixels to determine the worst cases.

24. The medium of claim 23 further storing instructions to determine whether or not at least one pixel of a group is lit.

25. The medium of claim 19 further storing instructions to identify the minimum and maximum depth value pixels of a group as the worst case pixels.

26. The medium of claim 25 further storing instructions to compare the minimum and maximum depth values of the group of pixels to minimum and maximum values stored in a hierarchical Z-buffer.

27. The medium of claim 26 further storing instructions to depth test at least two blocks of pixels in parallel.

28. An apparatus comprising:
a hierarchical Z-buffer; and
a control, coupled to said Z-buffer, to compare less than all the pixels of a group to values in said Z-buffer and to use said comparison as the depth test for all the pixels of said group.

29. The apparatus of claim 28, said control to use a group of pixels in a rectangular array.

30. The apparatus of claim 29, said control to identify the corner pixels of said rectangular array with maximum and minimum depth values.
